(19) United States
(12) Patent Application Publication
(10) Pub. No.: US 2024/0202696 A1
(43) Pub. Date: Jun. 20, 2024

(54) SYSTEMS AND METHODS FOR PERFORMING PAYMENTS IN AN EXTENDED REALITY ENVIRONMENT

(71) Applicant: Rovi Guides, Inc., San Jose, CA (US)

(72) Inventor: Charles Dasher, Lawrenceville, GA (US)

(21) Appl. No.: 18/082,769

(22) Filed: Dec. 16, 2022

(51) Int. Cl. G06Q 20/30; G06F 3/01; G06Q 20/40; G06T 7/20; G06T 7/70; G06T 19/00

(52) U.S. Cl. CPC G06Q 20/308; G06F 3/011; G06Q 20/40; G06T 7/20; G06T 7/70; G06T 19/006; G06T 2207/30196; G06T 2210/21

(57) ABSTRACT

Systems and methods are provided for enabling payments in an extended reality environment. A virtual space is mapped to a physical space at an extended reality device, and a virtual payment location is identified in the virtual space, where the virtual payment location corresponds to a location in the physical space. A collision with the virtual payment location is detected and a payment is initiated based on the collision. A payment request is transmitted from the extended reality device, and confirmation of the payment is received at the extended reality device. Confirmation of the payment is generated for output.

### BACKGROUND

The present disclosure is directed towards systems and methods for enabling payments in an extended reality environment. In particular, systems and methods are provided herein that enable payments to be performed in an extended reality environment based on the detection of a collision with a virtual payment location in the extended reality environment.

### SUMMARY

With the emergence of extended reality and the increasing importance of how people use extended reality to interact in their daily lives, people and companies will have an increasing need to send and receive payments for real goods and services in an augmented reality environment. People are used to interacting with payment systems in a seamless, and, increasingly, touchless manner. Existing payment services and protocols utilize technologies such as near field communications (NFC) and encryption to enable payments to be made in a touchless manner. Users within an extended reality experience may wish to interact with a payment system in a touchless way without leaving the extended reality experience to pay for items. In addition, existing physical locations may wish to add the ability to pay via an extended reality device or experience to existing point-of-sale systems.

To overcome these problems, systems and methods are provided herein that enable payments to be performed in an extended reality environment.

Systems and methods are described herein for enabling payments to be performed in an extended reality environment. In accordance with some aspects of the disclosure, a method is provided. The method includes mapping a virtual space to a physical space at an extended reality device and identifying a virtual payment location in the virtual space, where the virtual payment location corresponds to a location in the physical space. A collision with the virtual payment location is detected, and a payment is initiated based on the collision. A payment request is transmitted from the extended reality device, and confirmation of the payment is received at the extended reality device. Confirmation of the payment is generated for output. In some examples, detecting the collision may further comprise identifying a collision between a virtual element and the virtual payment location.

In an example system, a user wears an augmented reality headset and enters a shop that enables payments to be made via an augmented reality headset. A virtual space is mapped to the physical space of the shop. The augmented reality headset may perform this mapping or, in another example, a pre-defined map may be downloaded from a remote server, via a network such as the internet. A virtual payment location is identified in the virtual space. When a user wants to pay for one or more objects, they collide with the virtual space, for example by passing a virtual object through the virtual payment location. On detection of the collision, a payment for the object, or objects, is initiated at the augmented reality headset. The payment request may be transmitted to a point-of-sale device, or, in another example, directly to a remote server. The payment is processed via the point-of-sale device or the remote server, and confirmation of the payment is transmitted to the augmented reality headset. On receiving confirmation of the payment, the augmented reality headset generates confirmation of the payment for output, for example via a virtual element at the virtual payment location.

A spatial map of the virtual space may be received at the extended reality device, and a proximity of the extended reality device to the virtual payment location may be determined based on the spatial map. It may be determined that the proximity of the extended reality device to the virtual payment location is within a threshold distance, and a virtual element associated with the virtual payment location may be generated for output. The virtual element associated with the virtual element payment location may comprise transaction information associated with the payment.

A location of the extended reality device may be identified in physical space, and a proximity of the extended reality device to pre-determined coordinates in physical space may be determined. It may be determined that the proximity of the extended reality device to the pre-determined coordinates is within a threshold distance, and a virtual element associated with the virtual payment location may be generated for output.

Identifying a virtual payment location corresponding to a physical location may further comprise identifying a plurality of virtual payment locations, each virtual payment location corresponding to a physical location. A virtual payment location of the plurality of virtual payment locations may be identified based on a payment receiving status, and a virtual element associated with the identified virtual payment location may be generated for output.

Detecting the collision may further comprise tracking a location of a user limb in the physical space using limb tracking. The location of the user limb may be mapped to virtual space, and it may be identified that the location of at least a part of the user limb in virtual space corresponds to at least a part of the virtual payment location.

It may be identified that the payment is in progress, and the virtual payment location associated with the payment may be locked. A virtual element associated with the virtual payment location may be generated for output, where the virtual element indicates that the virtual payment location is locked.

A payment authorization request may be generated for output, and a payment authorization may be received. The payment authorization may be validated. Receiving confirmation of the payment may further comprise receiving confirmation of the payment in response to the payment authorization being validated.

A user profile may be accessed and a virtual element may be identified via the user profile. The identified virtual element at the virtual payment location may be generated for output.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows an example environment for enabling payments in an extended reality environment, in accordance with some embodiments of the disclosure;

FIG. 2 shows another example environment for enabling payments in an extended reality environment, in accordance with some embodiments of the disclosure;

FIG. 3 shows another example environment for enabling payments in an extended reality environment, in accordance with some embodiments of the disclosure;

FIG. 4 shows another example environment for enabling payments in an extended reality environment, in accordance with some embodiments of the disclosure;

FIG. 5 shows another example environment for enabling payments in an extended reality environment, in accordance with some embodiments of the disclosure;

FIG. 6 shows another example environment for enabling payments in an extended reality environment, in accordance with some embodiments of the disclosure;

FIG. 7 shows a flowchart of illustrative steps involved in creating virtual payment locations in an extended reality environment;

FIG. 8 shows a schematic diagram of virtual payment locations in an extended reality environment, in accordance with some embodiments of the disclosure;

FIG. 9 shows a flowchart of illustrative steps involved in enabling payments in an extended reality environment via an existing point-of-sale device;

FIG. 10 shows a schematic point-of-sale for enabling payments in an extended reality environment, in accordance with some embodiments of the disclosure;

FIG. 11 shows a flowchart of illustrative steps involved in determining which virtual payment locations are available for processing in an extended reality environment;

FIG. 12A shows another schematic diagram of virtual payment locations in an extended reality environment, in accordance with some embodiments of the disclosure;

FIG. 12B shows another schematic diagram of virtual payment locations in an extended reality environment, in accordance with some embodiments of the disclosure;

FIG. 13A shows another schematic diagram of virtual payment locations in an extended reality environment, in accordance with some embodiments of the disclosure;

FIG. 13B shows another schematic diagram of virtual payment locations in an extended reality environment, in accordance with some embodiments of the disclosure;

FIG. 14 shows a flowchart of illustrative steps involved in enabling payments via an audible command in an extended reality environment;

FIG. 15 shows a flowchart of illustrative steps involved in enabling payments via a virtual element in an extended reality environment, in accordance with some embodiments of the disclosure;

FIG. 16A shows another schematic diagram of virtual payment locations in an extended reality environment, in accordance with some embodiments of the disclosure;

FIG. 16B shows another schematic diagram of virtual payment locations in an extended reality environment, in accordance with some embodiments of the disclosure;

FIG. 17 shows another flowchart of illustrative steps involved in enabling payments in an extended reality environment, in accordance with some embodiments of the disclosure;

FIG. 18 shows a schematic diagram of a virtual payment location in an extended reality environment, in accordance with some embodiments of the disclosure;

FIG. 19 shows a block diagram representing components of a computing device and dataflow therebetween for enabling payments in an extended reality environment, in accordance with some embodiments of the disclosure; and

FIG. 20 shows another flowchart of illustrative steps involved in enabling payments in an extended reality environment, in accordance with some embodiments of the disclosure.

### DETAILED DESCRIPTION

Systems and methods are described herein for enabling payments to be performed in an extended reality environment. An extended reality device includes any computing device that enables the physical world to be augmented with one or more virtual objects and/or enables physical and virtual objects to interact with one another. An extended reality device may comprise a headset that is worn by a user and that enables virtual elements, or objects, to be superimposed, or projected, onto the physical world. In one example, the extended reality device may comprise a transparent, or substantially transparent, lens onto which virtual elements are projected or displayed. In another example, an extended reality device may comprise an application running on a computing device comprising a camera, such as a tablet or smartphone. The application may display output from the camera and may superimpose, or draw, virtual elements onto the output from the camera. Extended reality devices include augmented reality devices and mixed reality devices. Virtual reality devices that enable physical objects to passthrough into a virtual world are also contemplated.

Generating for output includes displaying data and/or objects on a display integral to an augmented reality device, generating data and/or objects for display on a display connected to an augmented reality device, generating audio for output at one or more speakers integral to an augmented reality device and/or generating audio for output at one or more speakers connected to an augmented reality device.

A point-of-sale device is any device for initiating, recording and/or completing payment for transactions. A point-of-sale device includes a till, a cash register and/or a computing device running point-of-sale software. Payment requests from an augmented reality device may be integrated with existing point-of-sale devices. Some point-of-sale devices may receive a software update that enables them to initiate a payment with an extended reality device. In some examples, the extended reality device may include authentication circuitry and/or hardware that enables it to interact, and to authorize, payments with existing point-of-sale devices and/or payment-card machines. In some examples, an application running an augmented reality environment on an extended reality device may make an application programming interface (API) call to an existing payment processing platform, such as Google Pay or Apple Pay in response to detecting a collision in an extended reality environment. The extended reality device may include information required to complete a transaction via the payment processing platform, such as the item(s) being purchased, a quantity of the item(s) and/or a price of the items. The existing payment processing platform may be integrated with a point-of-sale device at the physical location. These examples of payment processing with an extended reality device are relevant to all examples and/or embodiments described herein.

The disclosed methods and systems may be implemented on one or more computing devices. As referred to herein, the computing device can be any device comprising a processor and memory, for example, a television, a smart television, a set-top box, an integrated receiver decoder (RD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, a smartwatch, a smart speaker, an augmented reality device, a mixed reality device, a virtual reality device, or any other television equipment, computing equipment, or wireless device, and/or combination of the same.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, floppy disk, USB drive, DVD, CD, media cards, register memory, processor caches, random access memory (RAM), etc.

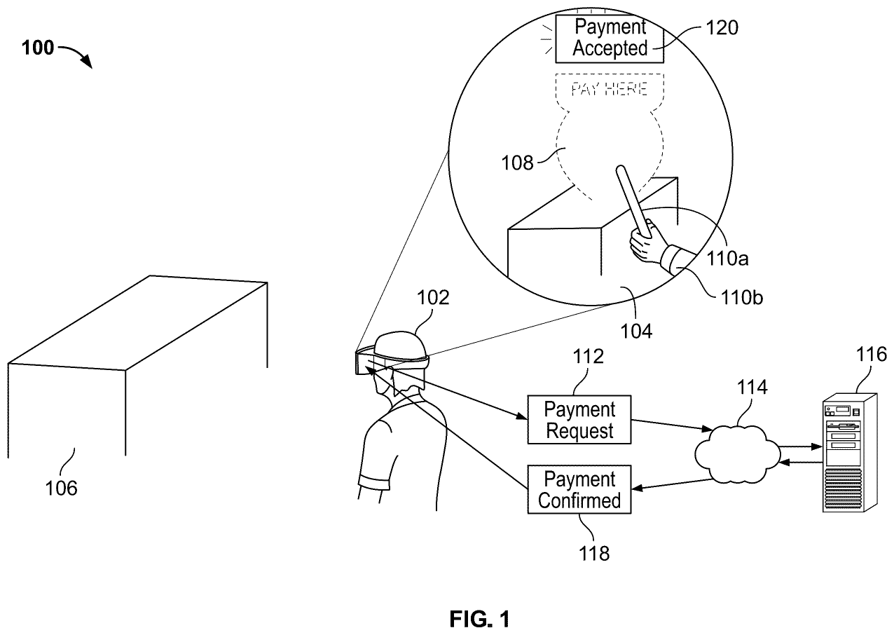

FIG. 1 shows an example environment for enabling payments in an extended reality environment, in accordance with some embodiments of the disclosure. The environment 100 comprises an extended reality device, such as an augmented reality headset 102; a physical location, including, for example, unit 106; a network 114; and a server 116. The augmented reality headset 102 spatially maps an extended reality environment, such as an augmented reality environment 104, based on the physical environment, including unit 106. In some examples, the augmented reality headset 102 may be performing simultaneous localization, mapping, and map optimization of an environment. The augmented reality headset 102 may use built-in sensors to create and manage a spatial map. This may take place at a remote server, for example in the cloud, where the spatial map and point cloud datasets are generated. The unit 106 may be, for example, any physical item in a location, including a table and/or a shelf.

A virtual payment location 108 is identified based on the physical environment. In this example, the virtual payment location 108 is associated with the unit 106. The virtual payment location 108 is shown in dashed lines, indicating that the virtual payment location itself is a set of coordinates in virtual space. The virtual payment location may be a two-dimensional payment location, defined by an area or plane in virtual space. In another example, the virtual payment location may be a three-dimension (3D) payment location, defined by a volume in virtual space. As discussed below, the virtual payment location may be indicated by one or more virtual elements that are generated for output by the extended reality device. In some examples, the virtual payment location may not have any virtual elements associated with it, but may be indicated, for example, by one or more physical objects.

In order to initiate a payment, the user collides with the virtual payment location. A collision is essentially where one object (virtual and/or physical) touches another object (virtual and/or physical) within a 3D coordinate system. A collision may be detected via, for example, an extended reality engine running on the augmented reality headset 102. This may be, for example, via a virtual element 110a that is held by the user. In some examples, the virtual element may be a virtual credit card and/or a totem representing a payment service. In another example, this may be, for example, via a physical limb 110b (such as a hand, arm, foot and/or leg) of the user, where a user's limb, or limbs, are tracked in order to detect a collision. In other examples (not shown) audio input from the user may be combined with the input. In further examples, the collision may be a virtual collision, where eye tracking is used to identify that a user has looked at a virtual payment location for longer than a threshold period of time. The collision may comprise the detection a part of, or the whole of, the virtual element and/or limb colliding with a part of the virtual payment location. In other examples, the collision may comprise passing the virtual element or physical limb through, or through a part of, the virtual payment location. In another example, this may comprise the user performing a gesture at, or in, the virtual payment location. In a further example, this may comprise the user gazing at the virtual payment location for a threshold amount of time. On detection of a collision, a payment request 112 is initiated at the augmented reality headset 102, and the payment request is transmitted via a network 114, such as the internet, to the server 116. The network may comprise wired and/or wireless means. At the server 116, the payment request is processed, and confirmation of the payment is transmitted, via the network 114, to the augmented reality headset 102. On receiving confirmation 118 of the payment, a visual element 120 indicating that the payment has been accepted may be generated for output in association with the virtual payment location 108. In other examples, generating the payment confirmation for output may comprise generating any visual and/or an audible confirmation. In other examples, this may alternatively, or additionally, comprise emailing a confirmation of the payment to an email address. Any of the aforementioned payment steps may be performed via a point-of-sale device instead of the augmented reality headset.

In some examples, in an extended reality environment, a 3D spatial mapping may be stored in a datastore that is accessible by an extended reality device. Within the 3D spatial mapping, a 3D area is recorded in metadata as a virtual payment location. This virtual payment location may comprise, for example, an x, y, z coordinate and a distance, or a plurality of x, y, z coordinates used to mark or identify a specific area within the 3D spatial map. Within the metadata for each virtual payment location, unique identifiers are be assigned. Additionally, service indicators (such as an indicator indicating that a particular payment method is accepted at the virtual payment location such as, for example, Apple Pay, Google Pay, VISA, Crypto currency and/or any other known payment method) may be recorded in the metadata associated with a virtual payment location. The metadata may be embedded within the 3D spatial map, or the metadata may exist in a separate data store that is accessible to the extended reality device.

An application running on a point-of-sale device may be configured to enable a transaction to be completed via a virtual payment location, or by communicating with a virtual payment location management application that may reside and be executed on a local or remote computing device, such as a server. When a transaction is ready for processing, for example, when payment is ready to be accepted, the application running on the point-of-sale device may request a list of virtual payment locations that are in an idle or unused state. The application running on the point-of-sale device may mark (for example, through an attribute of the virtual payment location within a virtual payment management application) one or more virtual payment locations as being ready to use. The application running on the point-of-sale device may send a request to a virtual payment location management application with, for example, transaction information. The transaction information may comprise a transaction identifier, items involved in the transaction (such as the items being purchased), item costs, assessed taxes, and the total cost.

In some examples, a transaction identifier, or a combination of attributes such as a transaction identifier, a virtual payment location unique identifier, a geo-location of the extended reality device and/or any other information associated with a transaction may be transmitted to a virtual payment location management system along with a payment service identifier (such as credit card information and/or other secure checkout information).

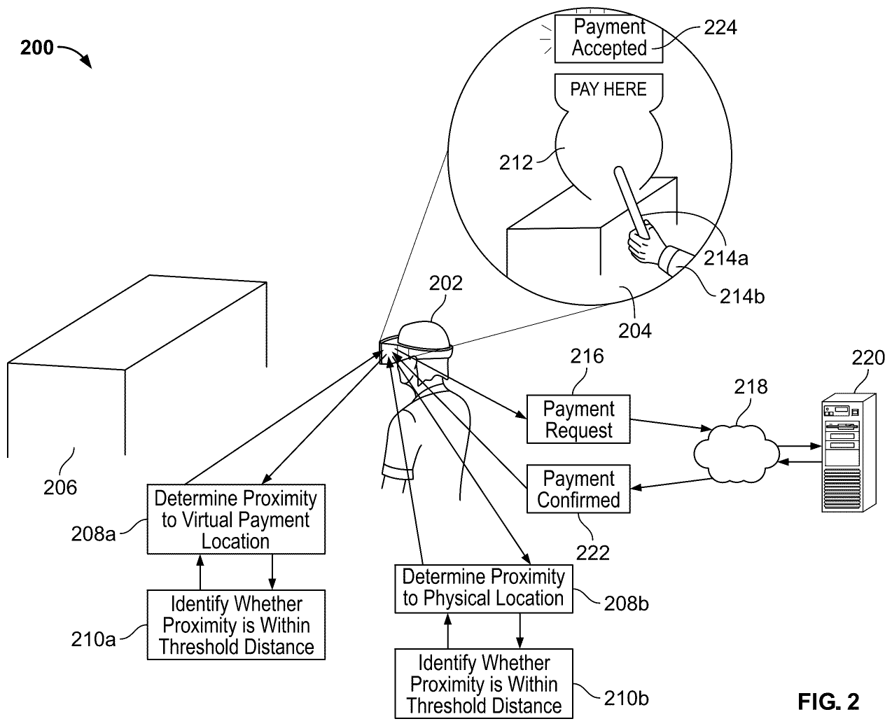

FIG. 2 shows another example environment for enabling payments in an extended reality environment, in accordance with some embodiments of the disclosure. In a similar manner to the environment shown in FIG. 1, the environment 200 comprises an extended reality device, such as an augmented reality headset 202; a physical location, including, for example, unit 206; a network 218; and a server 220. The augmented reality headset 202 spatially maps an extended reality environment, such as an augmented reality environment 204, based on the physical environment, including unit 206. The unit 206 may be, for example, any physical item in a location, including a table and/or a shelf. At 208a, the proximity of the augmented reality headset 202 to a virtual payment location is determined. For example, the proximity of the location of the augmented reality headset 202 in virtual space to a virtual payment location is determined. At 210a, it is identified whether the proximity of the augmented reality headset 202 is within a threshold distance. If the augmented reality headset 202 is within a threshold distance, a virtual element associated with the virtual payment location 212 is generated for output at the augmented reality headset 202.

In a variation, at 208b the proximity of the augmented reality headset 202 to a physical location is determined. For example, the proximity of the location of the augmented reality headset 202 to a physical location that is associated with a virtual payment location, such as unit 206, is determined. The physical location of the augmented reality headset 202 may be determined via geo-location data, network data, one or more proximity beacons and/or manual selection. Geo-location data may comprise, for example, latitude and longitude data, received, for example, via one or more satellite navigation systems, such as global positioning system (GPS), global navigation satellite system (GLONASS), Galileo, Beidou, NavIC and/or quasi-zenith satellite system (QZSS) satellites. Network data may comprise identifying a network access point, such as a Wi-Fi-enabled router, and accessing a database that correlates network access points with locations. A proximity beacon may be a Bluetooth-enabled device located in, or near, the retail establishment that transmits location data to other computing devices. Manual selection may comprise a user manually entering a location, such as the name and/or a location of a retail establishment. At 210b, it is identified whether the proximity of the augmented reality headset 202 is within a threshold distance. If the augmented reality headset 202 is within a threshold distance, a virtual element associated with the virtual payment location 212 is generated for output at the augmented reality headset 202. Determining the proximity of the augmented reality headset 202 to a location may be beneficial, for example, if a retail establishment comprises a plurality of virtual payment locations. By generating an indicator of only a virtual payment location, or locations, that is within a threshold proximity, processing power associated with generating visual elements for a virtual payment location may be reduced, as only those within a threshold distance are generated. This may provide an improved user experience in a location with many virtual payment locations, as it may help keep the display at the augmented reality headset 202 from becoming too crowded with virtual payment locations.

The virtual payment location 212 is identified based on the physical environment, and an element associated with the virtual payment location is generated for display. In this example, the virtual payment location 212 is associated with the unit 206. In order to initiate a payment, the user collides with the virtual payment location. This may be, for example, via a virtual element 214a that is held by the user. In another example, this may be, for example, via a physical limb 214b of the user. On detection of a collision, a payment request 216 is initiated at the augmented reality headset 202, and the payment request is transmitted via a network 218, such as the internet, to the server 220. At the server 220, the payment request is processed, and confirmation of the payment is transmitted, via the network 218, to the augmented reality headset 202. On receiving confirmation 222 of the payment, a visual element 224 indicating that the payment has been accepted may be generated for output in association with the virtual payment location 212. In other examples, generating the payment confirmation for output may comprise generating any visual and/or an audible confirmation. In other examples, this may alternatively, or additionally, comprise emailing a confirmation of the payment to an email address. Any of the aforementioned payment steps may be performed via a point-of-sale device instead of the augmented reality headset.

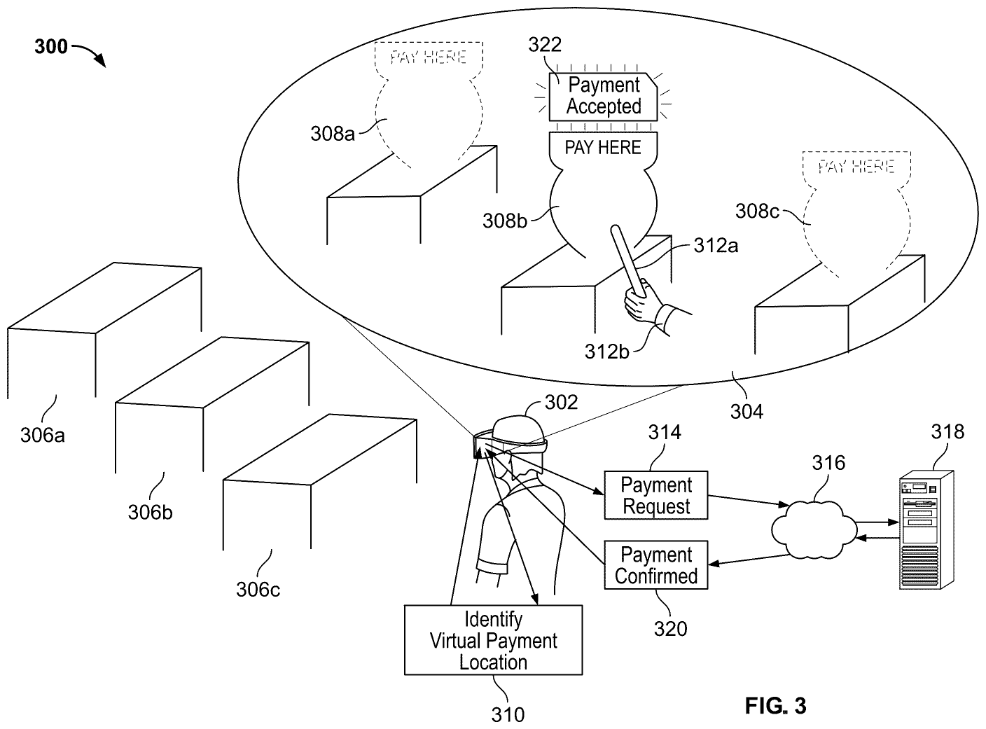

FIG. 3 shows another example environment for enabling payments in an extended reality environment, in accordance with some embodiments of the disclosure. In a similar manner to the environment shown in FIGS. 1 and 2, the environment 300 comprises an extended reality device, such as an augmented reality headset 302; a physical location, including, for example, first to third units 306a-c; a network 316; and a server 318. The augmented reality headset 302 spatially maps an extended reality environment, such as an augmented reality environment 304, based on the physical environment, including first to third units 306a-c. The units 306a-c may be, for example, any physical item in a location, including a table and/or a shelf A plurality of virtual payment locations 308a-c are identified based on the physical environment. In this example, first to third virtual payment locations 308a-c are associated with respective first to third units 306a-c. At 310, a virtual payment location for receiving a payment is identified. This may be based on, for example, the proximity of the augmented reality headset 302, or the user, to a virtual payment location, or a physical location, such as a unit 306a-c. In another example, this may be based on, for example, footfall and/or crowding at the physical location. For example, if lots of customers are in a particular area of the physical area, the user may be directed towards a virtual payment location in a less crowded area. In a further example, a cashier may select a virtual payment location via, for example, a point-of-sale device. In this example, the second virtual payment location 308b is identified, and an element associated with the second virtual payment location 308b is generated for display.

In order to initiate a payment, the user collides with the virtual payment location. This may be, for example, via a virtual element 312a that is held by the user. In another example, this may be, for example, via a physical limb 312b of the user. On detection of a collision, a payment request 314 is initiated at the augmented reality headset 302, and the payment request is transmitted via a network 316, such as the internet, to the server 318. At the server 318, the payment request is processed, and confirmation of the payment is transmitted, via the network 316, to the augmented reality headset 302. On receiving confirmation 320 of the payment, a visual element 322 indicating that the payment has been accepted may be generated for output in association with the virtual payment location 308b. In other examples, generating the payment confirmation for output may comprise generating any visual and/or an audible confirmation. In other examples, this may alternatively, or additionally, comprise emailing a confirmation of the payment to an email address. Any of the aforementioned payment steps may be performed via a point-of-sale device instead of the augmented reality headset.

In some examples, if an extended reality device has detected, either through its own determination or via a network indicator, that it is within a defined physical range (based on, for example, a tracked location of the augmented reality device relative to 3D spatial mapping) of a virtual payment location that has, for example, been marked as being ready for use, the extended reality device may display a visual cue such as, for example, a highlight, a color change of the virtual payment location, an avatar and/or another 3D model in association with the virtual payment location. In some examples, a point-of-sale system could continuously present or show a virtual payment location(s) as static or persistent objects within an extended reality application, and the visual cue may act upon, augment, and/or alter the appearance of such a static or persistent object. If a user needs to determine which virtual payment location is associated with a transaction, the user may physically move (within the 3D spatial map) closer to the virtual payment location. This may cause an extended reality application to send a request (including, for example, a virtual payment location unique identifier from metadata) to a virtual payment management application requesting pending transaction data. The virtual payment management application may return the transaction information for output at the extended reality device.

In some examples, a plurality of virtual payment locations may be created on demand based on, for example, pre-determined locations, or based on the location of an extended reality device. The location of the extended reality device may be identified via, for example, geo-location, triangulation of wireless signals (for example, via Bluetooth low energy or other wireless communication protocols), or based on the location of the extended reality device within the 3D extended reality mapped environment.

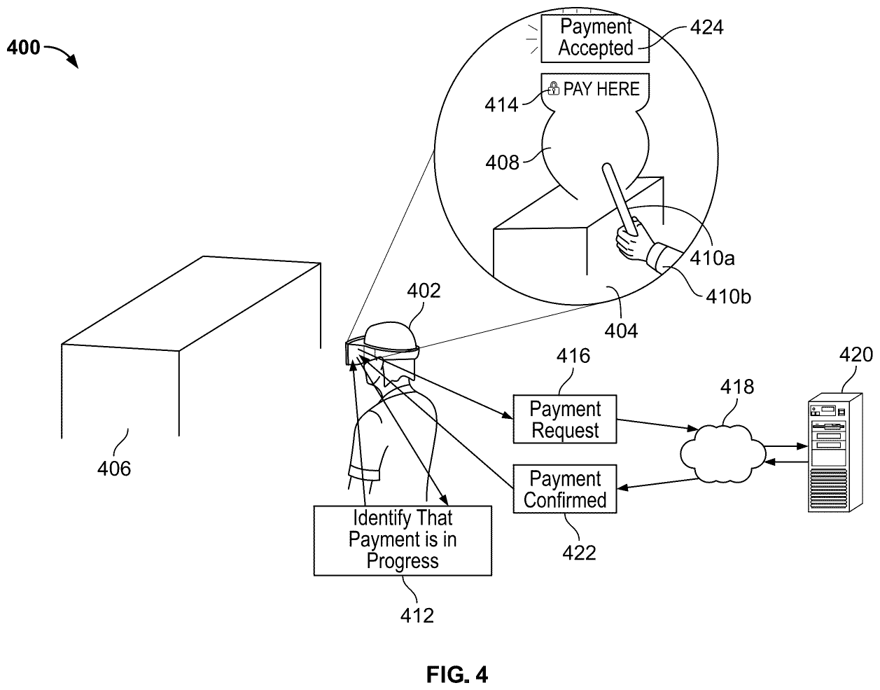

FIG. 4 shows another example environment for enabling payments in an extended reality environment, in accordance with some embodiments of the disclosure. In a similar manner to the environment shown in FIGS. 1-3, the environment 400 comprises an extended reality device, such as an augmented reality headset 402; a physical location, including, for example, unit 406; a network 418; and a server 420. The augmented reality headset 402 spatially maps an extended reality environment, such as an augmented reality environment 404, based on the physical environment, including unit 406. The unit 406 may be, for example, any physical item in a location, including a table and/or a shelf A virtual payment location 408 is identified based on the physical environment. In this example, the virtual payment location 408 is associated with the unit 406. In order to initiate a payment, the user collides with the virtual payment location. This may be, for example, via a virtual element 410a that is held by the user. In another example, this may be, for example, via a physical limb 410b of the user. On detection of a collision, it is identified that a payment is in progress 412, and a visual element 414 indicating that the payment is in progress is identified with the payment location 408. Although shown in connection with the virtual environment 404 of the augmented reality headset 402, the visual element 414 may be generated for output at extended reality devices of other users at the location, indicating that the virtual payment location 408 is in use and is locked, thereby preventing other users from using it. The virtual payment location may be locked via updating attributes associated with the virtual payment location, for example via metadata associated with the virtual payment location. This is in contrast to other scenarios, where multiple users may use a single virtual payment location at the same time.

A payment request 416 is initiated at the augmented reality headset 402, and the payment request is transmitted via a network 418, such as the internet, to the server 420. At the server 420, the payment request is processed, and confirmation of the payment is transmitted, via the network 418, to the augmented reality headset 402. On receiving confirmation 422 of the payment, a visual element 424 indicating that the payment has been accepted may be generated for output in association with the virtual payment location 408, and the virtual payment location 408 may be unlocked, for example, it may be returned to an unused and/or idle state. In addition, the visual element 414 may be removed from the virtual payment location. In other examples, generating the payment confirmation for output may comprise generating any visual and/or an audible confirmation. In other examples, this may alternatively, or additionally, comprise emailing a confirmation of the payment to an email address. Any of the aforementioned payment steps may be performed via a point-of-sale device instead of the augmented reality headset.

An application running on an extended reality device may be configured (through, for example, geolocation, detection of location beacons, manual selection, and/or any other known method) to request a 3D spatial map from the datastore, or to transmit its location and/or sensor data to a virtual payment location management system in order to determine the proximity of the extended reality device to a virtual payment location that has been marked as in use.

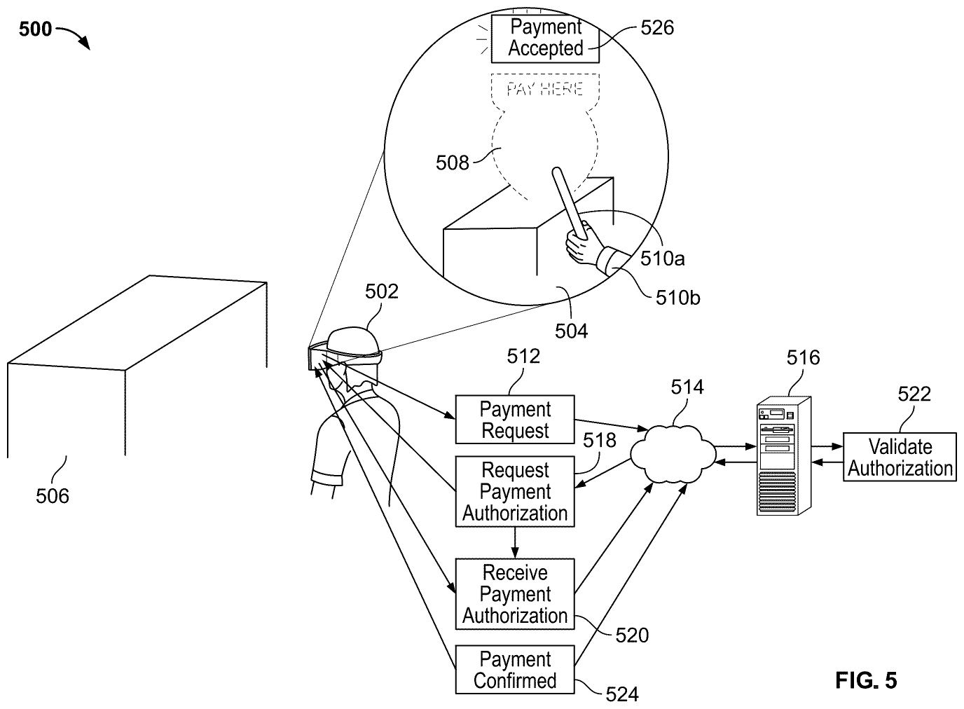

FIG. 5 shows another example environment for enabling payments in an extended reality environment, in accordance with some embodiments of the disclosure. In a similar manner to the environment shown in FIGS. 1-4, the environment 500 comprises an extended reality device, such as an augmented reality headset 502; a physical location, including, for example, unit 506; a network 514; and a server 516. The augmented reality headset 502 spatially maps an extended reality environment, such as an augmented reality environment 504, based on the physical environment, including unit 506. The unit 506 may be, for example, any physical item in a location, including a table and/or a shelf A virtual payment location 508 is identified based on the physical environment. In this example, the virtual payment location 508 is associated with the unit 506. In order to initiate a payment, the user collides with the virtual payment location. This may be, for example, via a virtual element 510a that is held by the user. In another example, this may be, for example, via a physical limb 510b of the user.

On detection of a collision, a payment request 512 is initiated at the augmented reality headset 502 and the payment request is transmitted via a network 514, such as the internet, to the server 516. At the server 516, the payment request is processed, and a payment authorization request 518 is transmitted, via the network 514, to the augmented reality headset 502. The user provides authorization at the augmented reality headset 502 via, for example, a pin number, a gesture, a phrase, selecting an input from a plurality of choices, a gesture and/or an authentication device. On receiving 520 the payment authorization, the authorization, or data based on the authorization, is transmitted via network 514 to the server 516, where the payment authorization is validated 522. On successfully validating the payment, confirmation of the payment is transmitted, via the network 514, to the augmented reality headset 502. On receiving confirmation 524 of the payment, a visual element 526 indicating that the payment has been accepted may be generated for output in association with the virtual payment location 508. In other examples, generating the payment confirmation for output may comprise generating any visual and/or an audible confirmation. In other examples, this may alternatively, or additionally, comprise emailing a confirmation of the payment to an email address. In another variation, if the payment is not successfully authorized at the server 522, the server 522 may transmit to the augmented reality headset 502, via network 514, a re-authorization request, where the user may provide the authorization again. Any of the aforementioned payment steps may be performed via a point-of-sale device instead of the augmented reality headset.

In some examples, the element that is used to initiate the payment, such as a payment service totem or other representation, may contain sand-boxed, secure execution or other security-related execution capabilities, in a similar manner to when an emulator is configured to execute within an extended reality environment. In these examples, the payment representation, or totem, may require additional interactions to identify and authenticate both the user and the virtual payment location and to authorize the transaction. For example, the totem (through its own execution code) could request a one-time payment nonce or identifier, which could be passed to a virtual payment location management system for processing.

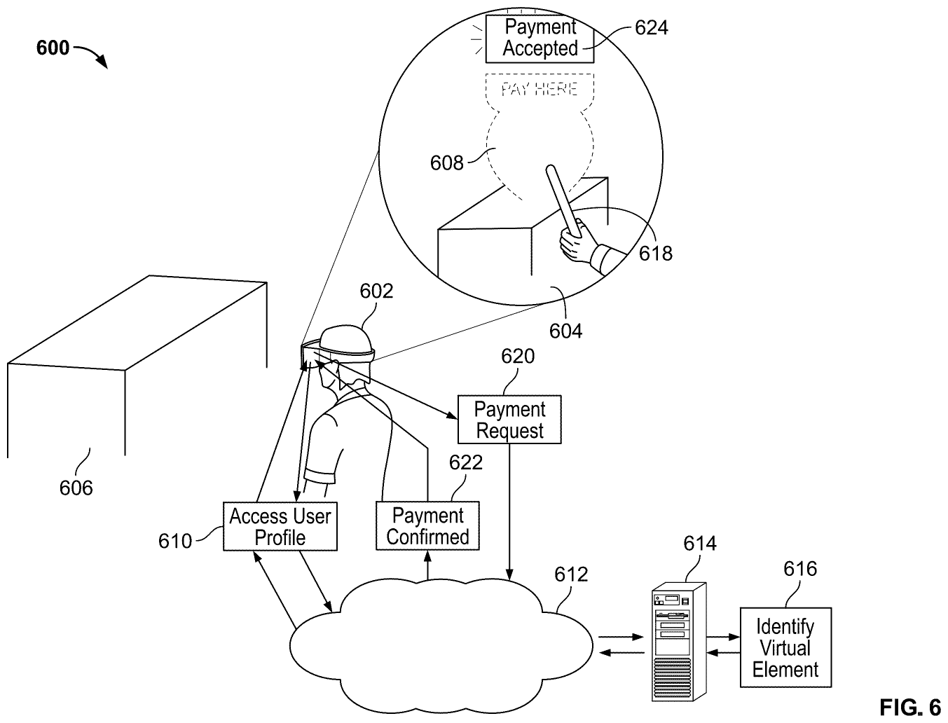

FIG. 6 shows another example environment for enabling payments in an extended reality environment, in accordance with some embodiments of the disclosure. In a similar manner to the environments shown in FIGS. 1-5, the environment 600 comprises an extended reality device, such as an augmented reality headset 602; a physical location, including, for example, unit 606; a network 612; and a server 614. The augmented reality headset 602 spatially maps an extended reality environment, such as an augmented reality environment 604, based on the physical environment, including unit 606. The unit 606 may be, for example, any physical item in a location, including a table and/or a shelf. A virtual payment location 608 is identified based on the physical environment. In this example, the virtual payment location 608 is associated with the unit 606. In response to identifying a virtual payment location, the augmented reality headset 602 accesses a user profile 610 and transmits a request, via the network 612, such as the internet, to the server 614. At the server 614, a virtual element for making the payment is identified 616. Data indicating the virtual element and/or data representing the virtual element is transmitted from the server 614, via the network 612, to the augmented reality headset 602. If an indication of the element is transmitted to the augmented reality headset 602, the augmented reality headset 602 may generate the virtual element 618 for display based on a selection of virtual elements stored at the augmented reality headset 602. If data representing the virtual element is transmitted to the augmented reality headset 602, the augmented reality headset 602 may generate the virtual element 618 based on the received data. In this way, a user can use a personalized element 618 to make payments.

In order to initiate a payment, the user collides their virtual element 618 with the virtual payment location. A payment request 620 is initiated at the augmented reality headset 602 and the payment request is transmitted via the network 612 to the server 614. At the server 614, the payment request is processed and confirmation of the payment is transmitted, via the network 612, to the augmented reality headset 602. On receiving confirmation 622 of the payment, a visual element 624 indicating that the payment has been accepted may be generated for output in association with the virtual payment location 608. In other examples, generating the payment confirmation for output may comprise generating any visual and/or an audible confirmation. In other examples, this may alternatively, or additionally, comprise emailing a confirmation of the payment to an email address. Any of the aforementioned payment steps may be performed via a point-of-sale device instead of the augmented reality headset.

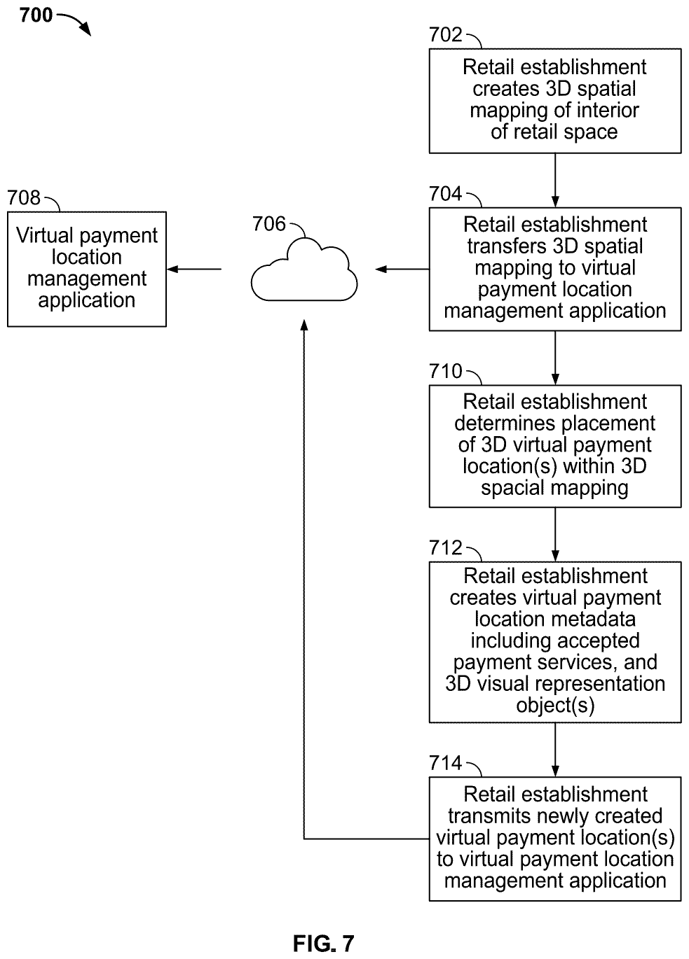

FIG. 7 shows a flowchart of illustrative steps involved in creating virtual payment locations in an extended reality environment, in accordance with some embodiments of the disclosure. Process 700 may be implemented on any of the aforementioned computing devices (e.g., computing device 102, 202, 302, 402, 502, 602). In addition, one or more actions of the process 700 may be incorporated into or combined with one or more actions of any other process or embodiments described herein.

At 702, a retail establishment creates a 3D spatial mapping of the interior of a retail space, such as a shop and/or restaurant. At 704, the retail establishment transfers the 3D spatial mapping to a virtual payment location management application via a network 706, such as the internet, at 708. In other examples, the network may be a local network and/or comprise local and remote components. The virtual payment location management application may be running on a server remote from the retail establishment. In addition, from step 704, the process proceeds to 710, where the retail establishment determines the placement of one or more 3D virtual payment locations within the 3D spatial mapping. At 712, the retail establishment creates virtual payment location metadata including, for example, accepted payment services and/or one or more 3D visual representation objects, or elements, which represent the virtual payment location in an extended reality environment. At 714, the retail establishment transmits the newly created one or more virtual payment locations, metadata including 3D visual representation objects and/or accepted payment services to the virtual payment location management application, via network 706, at 708.

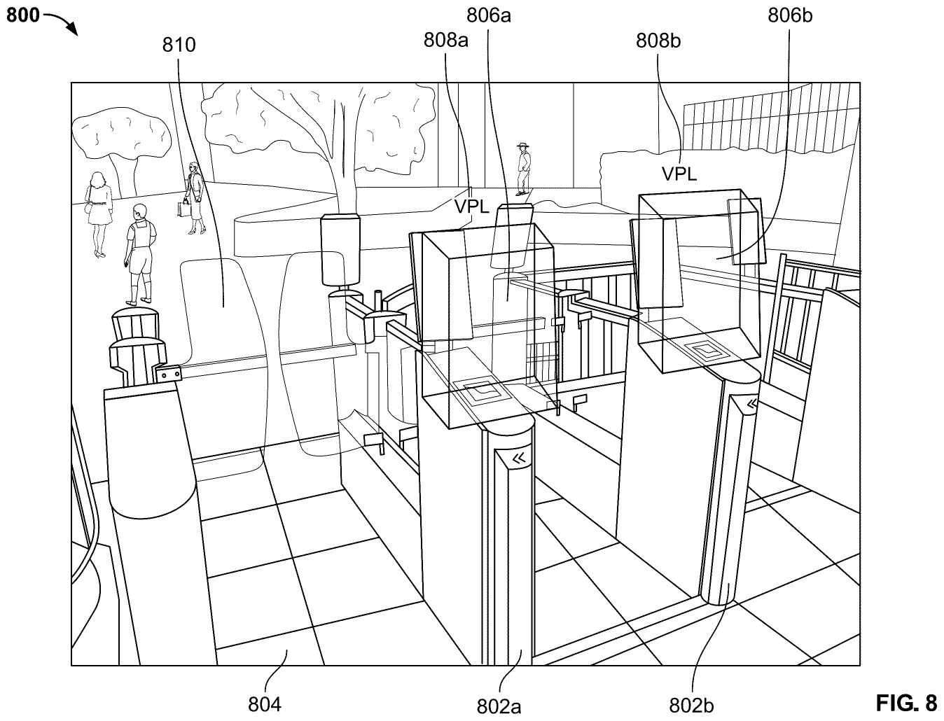

FIG. 8 shows a schematic diagram of virtual payment locations in an extended reality environment, in accordance with some embodiments of the disclosure. The environment 800 comprises first and second physical entry gates 802a, 802b. The physical environment 800 is spatially mapped 804. First and second virtual payment locations 806a, 806b are associated with respective first and second entry gates 802a, 802b. In addition, first and second labels 808a, 808b are optionally associated with respective first and second virtual payment locations. In this example, the labels read “VPL,” but in other examples, any suitable text and/or graphic may be associated with the virtual payment location. For example, the first virtual payment location 808a may have the text “Adult” associated with it, and the second virtual payment location 808b may have the text “Child” associated with it. Other examples include “Standard Access” and “Express Access.” In further examples, the text may be the name of an establishment, such as “Disney World.” On successfully receiving a payment via, for example, the first virtual payment location 808a, a physical gate 810 may open, allowing entry into, for example, a theme park.

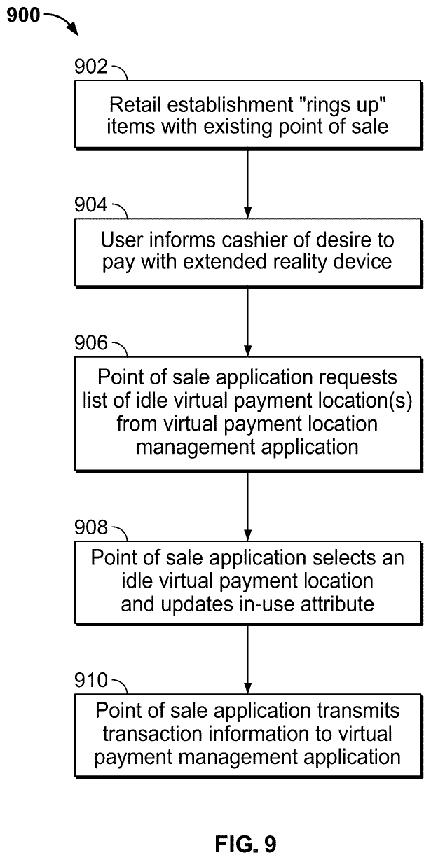

FIG. 9 shows a flowchart of illustrative steps involved in enabling payments in an extended reality environment via an existing point-of-sale device, in accordance with some embodiments of the disclosure. Process 900 may be implemented on any of the aforementioned computing devices (e.g., computing device 102, 202, 302, 402, 502, 602). In addition, one or more actions of the process 900 may be incorporated into or combined with one or more actions of any other process or embodiments described herein.

At 902, a cashier at, for example, a retail establishment, “rings up” (i.e., records the sale of) items that a customer is purchasing at an existing point-of-sale device. At 904, the customer informs the cashier that they desire to pay via an extended reality device, such as an augmented reality headset. At 906, in response to input from the cashier, an application running at the point-of-sale device requests, via, for example, a network such as the internet, a list of idle virtual payment locations from a virtual payment management application. In other examples, the network may be a local network and/or comprise local and remote components. The virtual payment management application may be running on a server remote from the retail establishment. At 908, the point-of-sale application selects an idle virtual payment location and updates an “in-use” attribute of the selected virtual payment location. At 910, the point-of-sale application transmits data associated with the transaction to the virtual payment management application via, for example, the network.

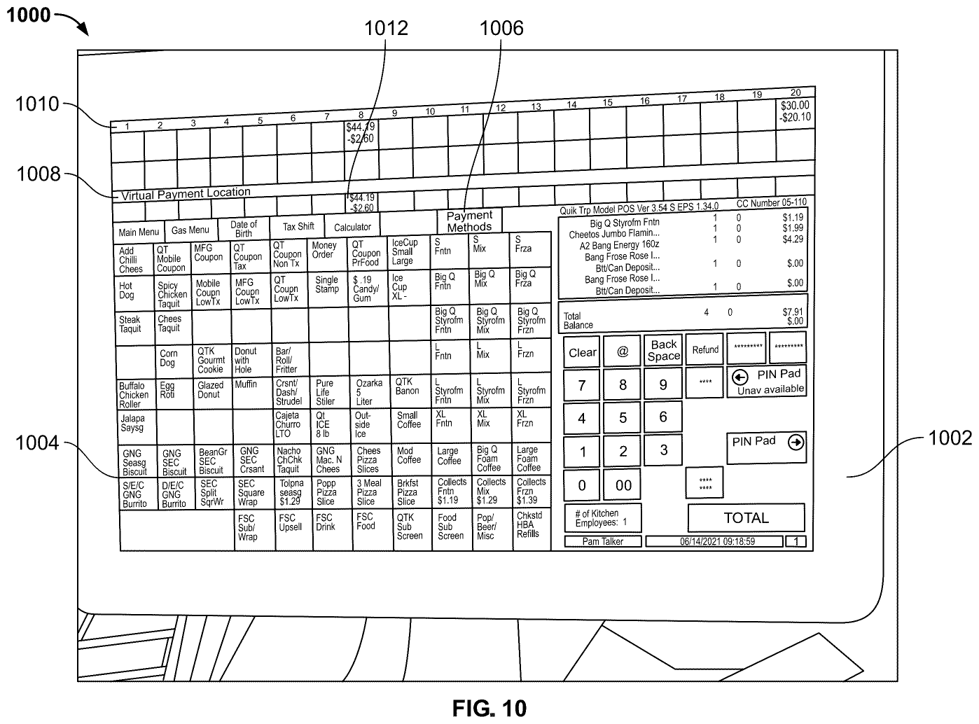

FIG. 10 shows a schematic point-of-sale for enabling payments in an extended reality environment, in accordance with some embodiments of the disclosure. The environment 1000 comprises a point-of-sale device 1002. The point-of-sale device 1002 generates a user interface 1004 for display. The user interface comprises a button 1006 that enables a user, such as a cashier, to select how a customer pays, for example, via an extended reality device. On selection, the button 1006 may cause a further user interface screen to be generated for display (not shown) that enables the user to select the payment method. The user interface 1004 may comprise a user interface element 1008 that indicates which virtual payment locations are available for a customer to pay by. The user interface 1004 may comprise an additional user interface element 1010 that, for example, associates numbers with the different virtual payment locations for ease of reference. The user interface 1004 may enable the user to select a virtual payment location for a customer to pay with via a selectable user interface element 1012. On the selection of a virtual payment location, in some examples, an indication of the virtual payment location may be transmitted to an extended reality device associated with a customer. The extended reality device may output the indication of the virtual payment location and/or directions to the virtual payment location, where the customer proceeds to pay. In another example, a unit, such as units 106, 206, 306a-c, 406, 506, 606 described herein, may be associated with a point-of-sale device, and may comprise a physical, or virtual, sign indicating that a customer needs to pay at that location if they are paying via an extended reality device. In another example, a virtual payment location is selected by virtue of a particular point-of-sale device being used, as a virtual payment location may be associated with a particular point-of-sale device.

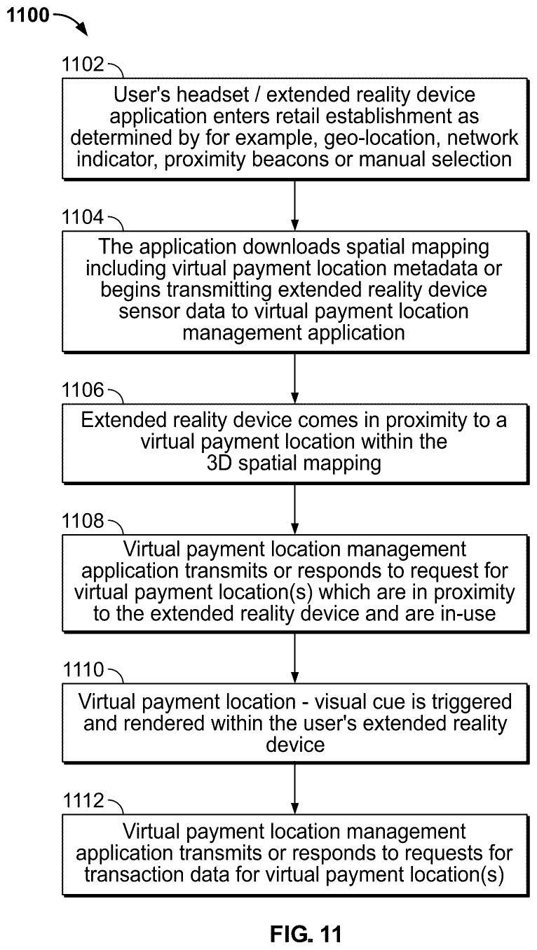

FIG. 11 shows a flowchart of illustrative steps involved in determining which virtual payment locations are available for processing in an extended reality environment, in accordance with some embodiments of the disclosure. Process 1100 may be implemented on any of the aforementioned computing devices (e.g., computing device 102, 202, 302, 402, 502, 602). In addition, one or more actions of the process 1100 may be incorporated into or combined with one or more actions of any other process or embodiments described herein.

At 1102, an application running on an extended reality device, such as an augmented reality headset, determines that the extended reality device has entered a retail establishment via, for example, geo-location data, network data, one or more proximity beacons and/or manual selection. Geo-location data may comprise, for example, latitude and longitude data, received, for example, via one or more satellite navigation systems, such as global positioning system (GPS), global navigation satellite system (GLONASS), Galileo, Beidou, NavIC and/or quasi-zenith satellite system (QZSS) satellites. Network data may comprise identifying a network access point, such as a Wi-Fi-enabled router, and accessing a database that correlates network access points with locations. A proximity beacon may be a Bluetooth-enabled device located in, or near, the retail establishment that transmits location data to other computing devices. Manual selection may comprise a user manually entering a location, such as the name and/or a location of a retail establishment.

At 1104, the application running on the extended reality device downloads via, for example, a network such as the internet, spatial mapping, including virtual payment location metadata from, for example, a server. In other examples, the network may be a local network and/or comprise local and remote components. Alternatively, the extended reality device begins transmitting sensor data, such as extended reality device sensor data, from the extended reality device to a virtual payment location management application via, for example, the network. The virtual payment location management application may be running on a server remote from the retail establishment. At 1106, the extended reality device comes into proximity to a virtual payment location within the 3D spatial mapping. At 1108, the virtual payment management application transmits, or responds to, a request, via, for example, the network, for one or more virtual payment locations that are in proximity to the extended reality device and are in use. At 1110, a visual cue(s) for the in-use virtual payment location, or locations, is triggered and rendered within, or remote from, the extended reality device and output for display. At 1112, the virtual payment location management application transmits, or responds to, requests for transaction data for the virtual payment location, or locations via, for example, the network.

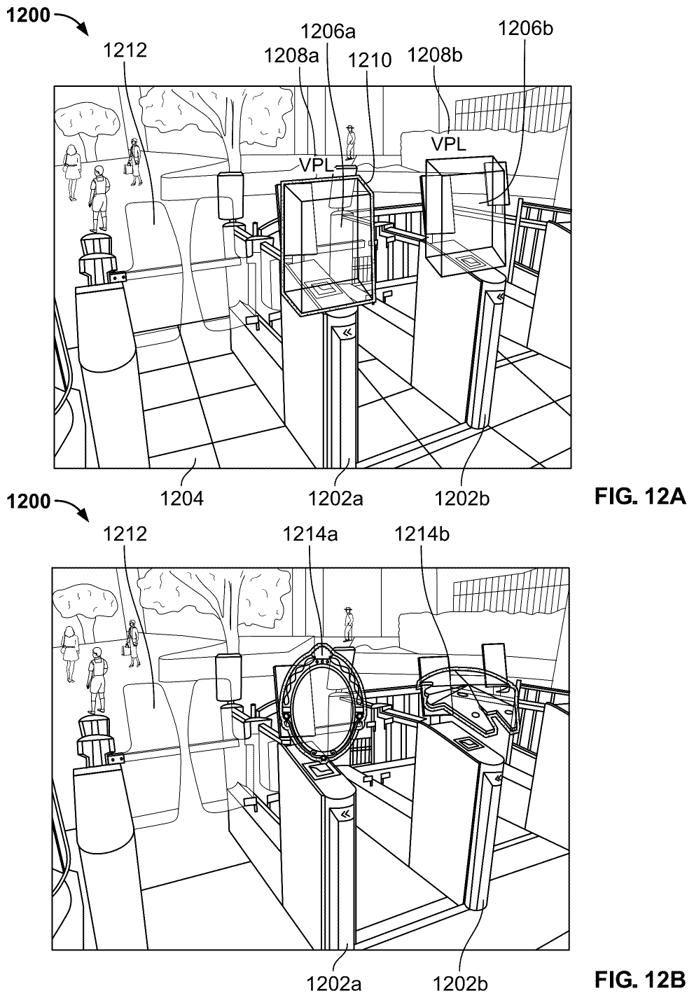

FIG. 12A shows another schematic diagram of virtual payment locations in an extended reality environment, in accordance with some embodiments of the disclosure. In a similar manner to the environment shown in FIG. 8, the environment 1200 comprises first and second physical entry gates 1202a, 1202b. The physical environment 1200 is spatially mapped 1204. First and second virtual payment locations 1206a, 1206b are associated with respective first and second entry gates 1202a, 1202b. In addition, first and second labels 1208a, 1208b are optionally associated with respective first and second virtual payment locations. A visual element 1210 is associated with the first virtual payment location 1208a, indicating that this virtual payment location should be used for payment. On successfully receiving a payment via the first virtual payment location 1208a, a physical gate 1212 may open, allowing entry into, for example, a theme park.

FIG. 12B shows another schematic diagram of virtual payment locations in an extended reality environment, in accordance with some embodiments of the disclosure. In a similar manner to the environment shown in FIGS. 8 and 12A, the environment 1200 comprises first and second physical entry gates 1202a, 1202b. The physical environment 1200 is spatially mapped. First and second virtual payment locations are associated with respective first and second entry gates 1202a, 1202b. In this example, custom elements 1214a, 1214b are associated with the first and second virtual payment locations. In this example, the custom elements 1214a, 1214b are different, but the same custom element could be associated with all virtual payment locations. In some examples, the custom elements may be defined by the location, such as a retail establishment and/or theme park, and may be transmitted to an extended reality device. In other examples, a user may select a custom element to be associated with a virtual payment location. In some examples, these may be the 3D visual representation objects that were uploaded by the merchant at step 712 in FIG. 7. On successfully receiving a payment via, for example, the first virtual payment location, a physical gate 1212 may open, allowing entry into, for example, a theme park.

In some examples, the user may securely upload a custom 3D visual representation to a virtual payment management application via, for example, an extended reality device and/or a web portal. The uploaded custom visual representation may be securely stored and, for example, associated with a user profile. On entering a store associated with, for example, a particular merchant, this custom virtual representation can be securely shared with the merchant, via the user profile, and be used at any virtual payment location associated with that merchant. In this way, when the user visits a particular merchant and goes to pay, they can expect to see their custom visual representation. Having the visual representation of the virtual payment location pre-defined in this manner may be used to add an additional level of security, as the visual representation could serve as a challenge to the end user to prevent spoofing of a virtual payment location. A third party attempting to spoof a virtual payment location would not know what visual representation to associate with a spoofed virtual payment location for a merchant. In another example, the visual representation may be a way to provide users with an integrated experience, for example, a fan of the “Star Wars” films could choose the Millennium Falcon as a preferred virtual payment location representation.

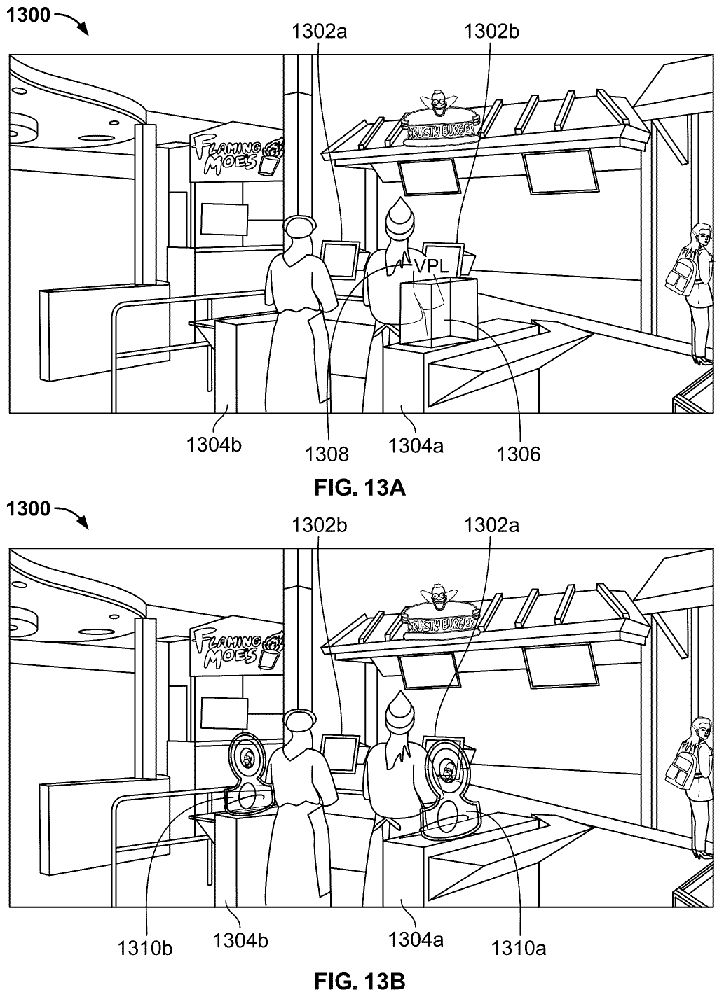

FIG. 13A shows another schematic diagram of virtual payment locations in an extended reality environment, in accordance with some embodiments of the disclosure. The environment 1300 comprises first and second point-of-sale devices 1302a, 1302b and first and second physical payment locations 1304a, 1304b. In this example, a virtual payment location 1306 is associated with the first physical location 1304a. The first point-of-sale device 1302a may be configured to enable a user to pay with an augmented reality device at the first physical location 1304a, via the virtual payment location 1306. The virtual payment location optionally has a label 1308 associated with it. In this example, a user may pay for food at a restaurant via the virtual payment location.

FIG. 13B shows another schematic diagram of virtual payment locations in an extended reality environment, in accordance with some embodiments of the disclosure. In a similar manner to the environment shown in FIG. 13A, the environment 1300 comprises first and second point-of-sale devices 1302a, 1302b and first and second physical payment locations 1304a, 1304b. The first and second point-of-sale devices 1302a, 1302b may be configured to enable a user to pay with an augmented reality device at respective first and second physical locations 1304a, 1304b via respective virtual payment locations. The virtual payment locations have custom elements 1310a, 1310b associated with them. In this example, a user may pay for food at a restaurant via the virtual payment location.

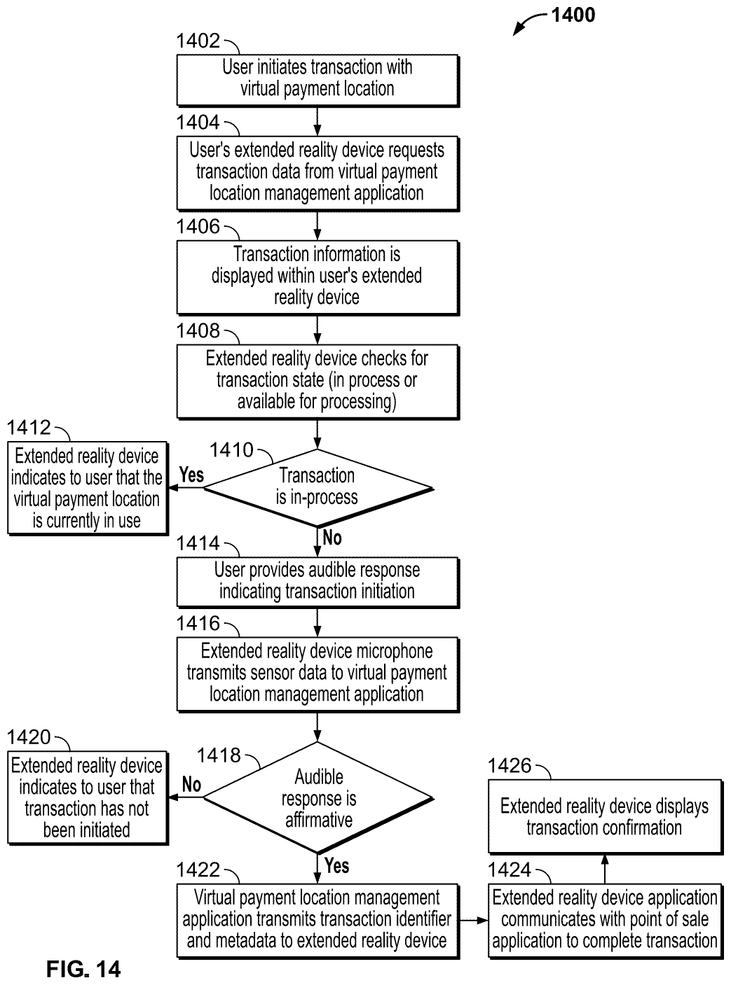

FIG. 14 shows a flowchart of illustrative steps involved in enabling payments via an audible command in an extended reality environment, in accordance with some embodiments of the disclosure. Process 1400 may be implemented on any of the aforementioned computing devices (e.g., computing device 102, 202, 302, 402, 502, 602). In addition, one or more actions of the process 1400 may be incorporated into or combined with one or more actions of any other process or embodiments described herein.

At 1402, a user initiates a transaction with a virtual payment location via, for example, a virtual reality device, such as an augmented reality headset. At 1404, the user's extended reality device requests transaction data from a virtual payment location management application via, for example, a network such as the internet. In other examples, the network may be a local network and/or comprise local and remote components. The virtual payment location management application may be running on a server remote from the retail establishment. At 1406, transaction information, received from the virtual payment location management application, is generated for output at the user's extended reality device. At 1408, the extended reality device checks for a transaction state of a virtual payment location via, for example, the network. For example, the extended reality device checks whether the virtual payment location is processing a payment or is available for processing a payment. At 1410, it is determined whether a transaction is in process. At 1412, if it is determined that a transaction is in process, the extended reality device indicates to the user that the virtual payment location is currently in use. For example, the extended reality device may generate an indicator for output.

If it is determined at 1410 that a transaction is not in process, at 1414, the user provides an audible response, indicating the initiation of a transaction. This input may be provided via, for example, a microphone of the extended reality device and/or a point-of-sale device. At 1416, in this example, a microphone of the extended reality device transmits, for example, via the network, the input to a virtual payment location management application. The virtual payment location management application may be running on, for example, a server remote from the extended reality device.

At 1418, it is determined whether the audible response is affirmative. If the audible response is not affirmative, at 1420, the extended reality device indicates to the user that the transaction has not be initiated. This may be via, for example, the generation of a visual and/or audible cue for output. If the response is affirmative, at 1422, the virtual payment location management application transmits via, for example, the network, a transaction identifier and/or metadata to the extended reality device. At 1424, an application running on the extended reality device communicates with an application running on a point-of-sale device to complete the transaction. At 1426, the extended reality device generates confirmation of the transaction for output. In another example, the virtual payment location management application may additionally, or alternatively, transmit confirmation of the transaction to another computing device. For example, the virtual payment location management application may email a receipt for the transaction to an email address associated with the user.

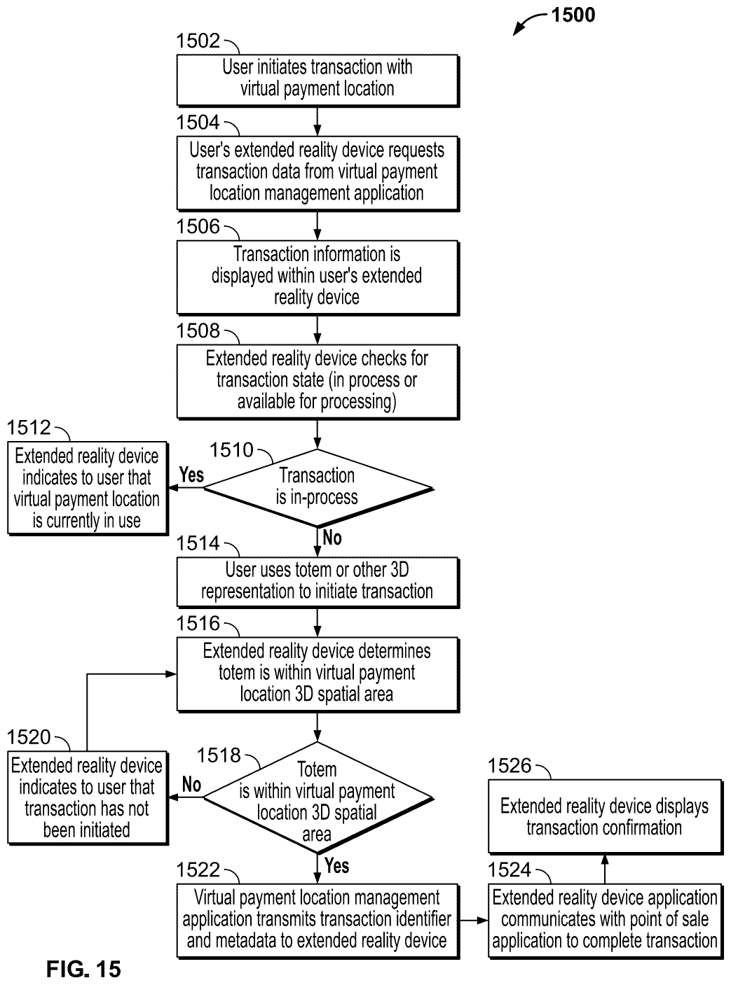

FIG. 15 shows a flowchart of illustrative steps involved in enabling payments via a virtual element in an extended reality environment, in accordance with some embodiments of the disclosure. Process 1500 may be implemented on any of the aforementioned computing devices (e.g., computing device 102, 202, 302, 402, 502, 602). In addition, one or more actions of the process 1500 may be incorporated into or combined with one or more actions of any other process or embodiments described herein.

At 1502, a user initiates a transaction with a virtual payment location via, for example, a virtual reality device, such as an augmented reality headset. At 1504, the user's extended reality device requests transaction data from a virtual payment location management application via, for example, a network such as the internet. In other examples, the network may be a local network and/or comprise local and remote components. The virtual payment location management application may be running on a server remote from the retail establishment. At 1506, transaction information, received from the virtual payment location management application, is generated for output at the user's extended reality device. At 1508, the extended reality device checks for a transaction state of a virtual payment location via, for example, the network. For example, the extended reality device checks whether the virtual payment location is processing a payment or is available for processing a payment. At 1510, it is determined whether a transaction is in process. If it is determined that a transaction is in process, at 1512, the extended reality device indicates to the user that the virtual payment location is currently in use. For example, the extended reality device may generate an indicator for output.

If it is determined that a transaction is not in process, at 1514, the user uses a totem, or other 3D representation, or element, to initiate a transaction. At 1516, the extended reality device determines whether the, for example, totem is within the 3D spatial area of a virtual payment location. At 1518, it is determined whether the, for example, totem is within the 3D spatial area of the virtual payment location. If the, for example, totem is not in the 3D spatial area of the virtual payment location, the process proceeds to step 1520, where the extended reality device indicates to the user that the transaction has not been initiated. For example, the extended reality device may generate for output an indicator that the transaction has not been initiated. The process proceeds back to step 1516. If the, for example, totem is in the 3D spatial area of the virtual payment location, the process proceeds to step 1522, where the virtual payment location management application transmits via, for example, the network, a transaction identifier and/or metadata to the extended reality device. At 1524, an application running on the extended reality device communicates with an application running on a point-of-sale device to complete the transaction. At 1526, the extended reality device generates confirmation of the transaction for output. In another example, the virtual payment location management application may additionally, or alternatively, transmit confirmation of the transaction to another computing device. For example, the virtual payment location management application may email a receipt for the transaction to an email address associated with the user.

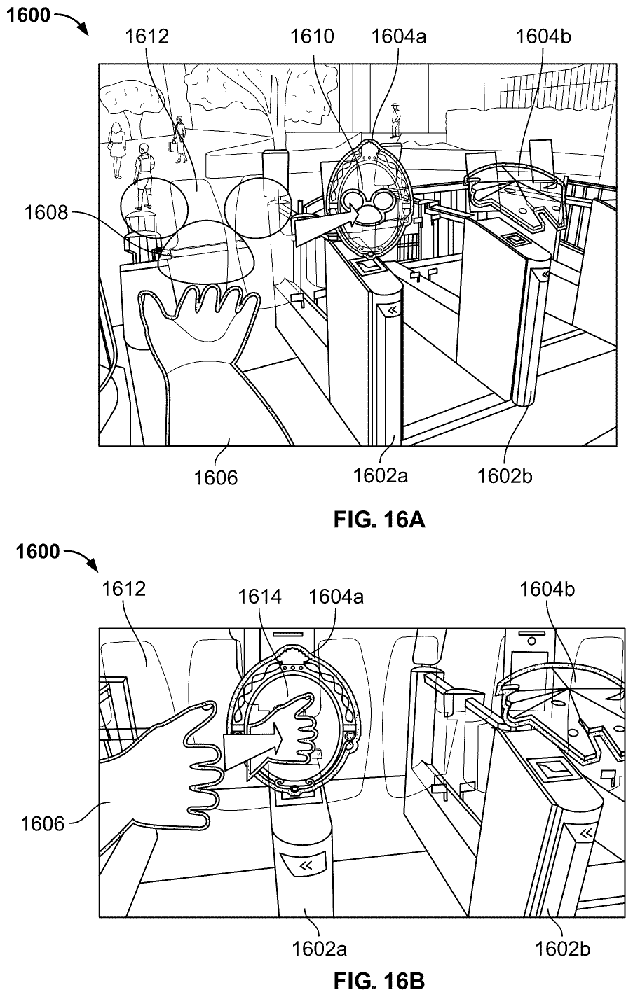

FIG. 16A shows another schematic diagram of virtual payment locations in an extended reality environment, in accordance with some embodiments of the disclosure. In a similar manner to the environment shown in FIGS. 8, 12A and 12B, the environment 1600 comprises first and second physical entry gates 1602a, 1602b. The physical environment 1600 is spatially mapped. First and second virtual payment locations are associated with respective first and second entry gates 1602a, 1602b. In this example, custom elements 1604a, 1604b are associated with the first and second virtual payment locations. A user 1606 uses a custom element 1608 to initiate a collision 1610 with the virtual payment location. For example, the user may hold the custom element 1608 in the virtual environment and may manipulate the custom element to collide with the virtual payment location. In some examples, the custom element 1608 used to initiate the collision may be defined by the location, such as a retail establishment and/or theme park, and may be transmitted to an extended reality device. In other examples, a user may select a custom element 1608 to initiate the collision with. On successfully receiving a payment via, for example, the first virtual payment location, a physical gate 1612 may open, allowing entry into, for example, a theme park.

FIG. 16B shows another schematic diagram of virtual payment locations in an extended reality environment, in accordance with some embodiments of the disclosure. In a similar manner to the environment shown in FIGS. 8, 12A, 12B and 16A, the environment 1600 comprises first and second physical entry gates 1602a, 1602b. The physical environment 1600 is spatially mapped. First and second virtual payment locations are associated with respective first and second entry gates 1602a, 1602b. In this example, custom elements 1604a, 1604b are associated with the first and second virtual payment locations. A user 1606 uses their hand to initiate a collision 1614 with the virtual payment location. For example, the user may pass their hand through virtual coordinates corresponding with the virtual payment location. On successfully receiving a payment via, for example, the first virtual payment location, a physical gate 1612 may open, allowing entry into, for example, a theme park.

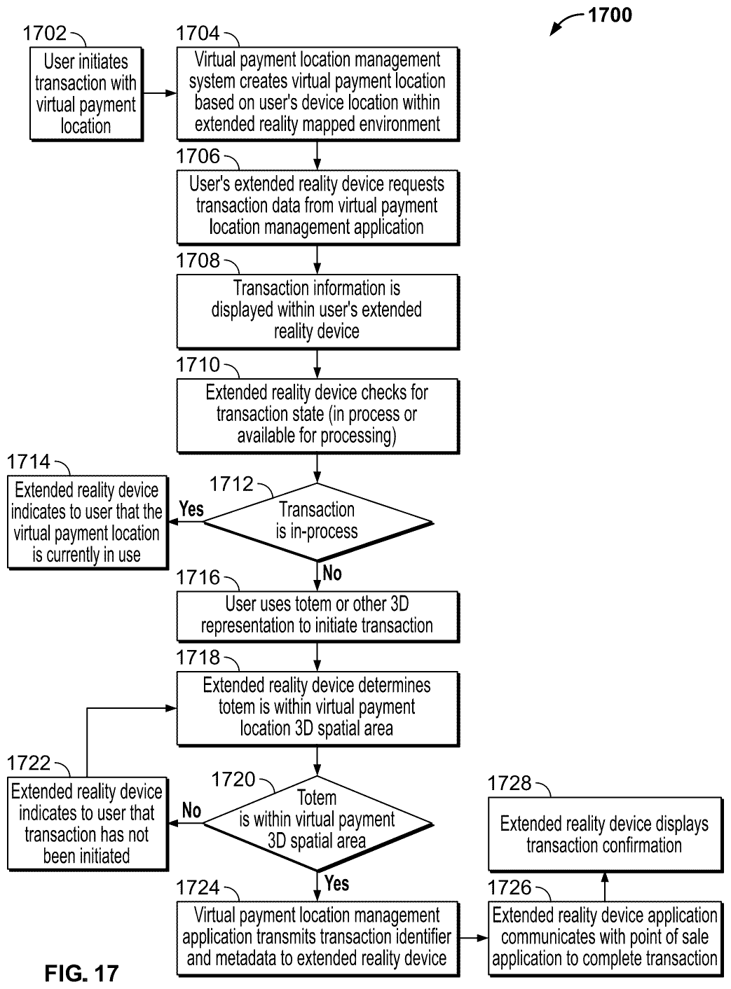

FIG. 17 shows another flowchart of illustrative steps involved in enabling payments in an extended reality environment, in accordance with some embodiments of the disclosure. Process 1700 may be implemented on any of the aforementioned computing devices (e.g., computing device 102, 202, 302, 402, 502, 602). In addition, one or more actions of the process 1700 may be incorporated into or combined with one or more actions of any other process or embodiments described herein.

At 1702, a user initiates a transaction with a virtual payment location via, for example, a virtual reality device, such as an augmented reality headset. At 1704, a virtual payment location management system creates a virtual payment location based on the location of the user's extended reality device within an extended reality mapped environment. To enable the creation of a virtual payment location, the user's augmented reality headset may, for example, transmit location data to the virtual payment location management system via a network, such as the internet. In other examples, the network may be a local network and/or comprise local and remote components. The virtual payment location management application may be running on a server remote from the retail establishment. At 1706, the user's extended reality device requests transaction data from a virtual payment location management application via, for example, the network. At 1708, transaction information, received from the virtual payment location management application, is generated for output at the user's extended reality device. At 1710, the extended reality device checks for a transaction state of a virtual payment location via, for example, the network. For example, the extended reality device checks whether the virtual payment location is processing a payment or is available for processing a payment. At 1712, it is determined whether a transaction is in process. At 1714, if it is determined that a transaction is in process, the extended reality device indicates to the user that the virtual payment location is currently in use. For example, the extended reality device may generate an indicator for output.

At 1716, if it is determined that a transaction is not in process, the user uses a totem, or other 3D representation, or element, to initiate a transaction. At 1718, the extended reality device determines whether the, for example, totem is within the 3D spatial area of a virtual payment location. At 1720, it is determined whether the, for example, totem is within the 3D spatial area of the virtual payment location. If the, for example, totem is not in the 3D spatial area of the virtual payment location, the process proceeds to step 1722, where the virtual reality indicates to the user that the transaction has not been initiated. For example, the extended reality device may generate for output an indicator that the transaction has not been initiated. The process proceeds back to step 1718. If the, for example, totem is in the 3D spatial area of the virtual payment location, the process proceeds to step 1724, where the virtual payment location management application transmits via, for example, the network, a transaction identifier and/or metadata to the extended reality device. At 1726, an application running on the extended reality device communicates with an application running on a point-of-sale device to complete the transaction. At 1728, the extended reality device generates confirmation of the transaction for output. In another example, the virtual payment location management application may additionally, or alternatively, transmit confirmation of the transaction to another computing device. For example, the virtual payment location management application may email a receipt for the transaction to an email address associated with the user.

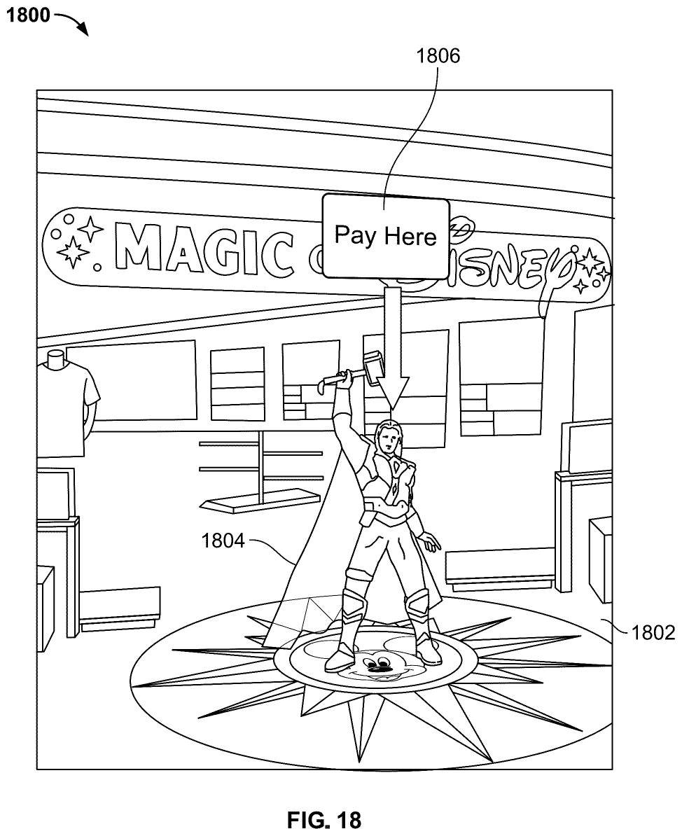

FIG. 18 shows a schematic diagram of a virtual payment location in an extended reality environment, in accordance with some embodiments of the disclosure. The environment 1800 comprises a physical retail location 1802, a virtual payment location 1804 and a label 1806 associated with the virtual payment location. In this example, due to the size of the virtual payment location 1804, a user may walk through the virtual payment to initiate a payment. In another example, a defined gesture, such as a “high-five” with a character at the virtual payment location 1804 may be used to initiate a payment.

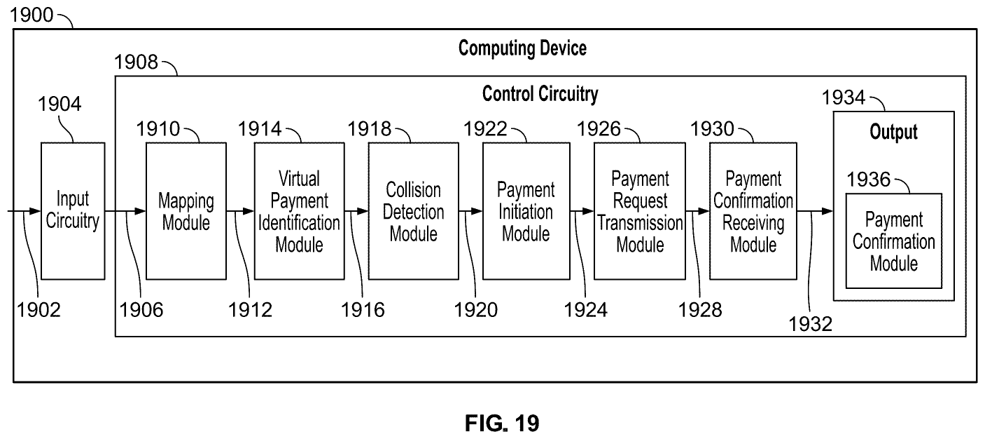

FIG. 19 shows a block diagram representing components of a computing device and dataflow therebetween for enabling payments in an extended reality environment, in accordance with some embodiments of the disclosure. Computing device 1900 (e.g., computing device 102, 202, 302, 402, 502, 602), as discussed above, comprises input circuitry 1904, control circuitry 1908 and output module 1934. Control circuitry 1908 may be based on any suitable processing circuitry (not shown) and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 888). Some control circuits may be implemented in hardware, firmware, or software.

Input is received 1902 by the input circuitry 1904. The input circuitry 1902 is configured to received inputs related to a computing device. For example, this may be via gesture detected via an extended reality device. In other examples, this may be via an infrared controller, Bluetooth and/or Wi-Fi controller of the computing device 1900, a touchscreen, a keyboard, a mouse and/or a microphone. In another example, the input may comprise instructions received via another computing device. The input circuitry 1904 transmits 1906 the user input to the control circuitry 1908.

The control circuitry 1908 comprises a mapping module 1910, a virtual payment identification module 1914, a collision detection module 1918, a payment initiation module 1922, a payment request transmission module 1926, a payment confirmation receiving module 1930 and an output module 1934 comprising a payment confirmation module 1936. The input is transmitted 1906 to the mapping module 1910, where a 3D spatial mapping of a virtual environment, such as an augmented reality environment, is created. An indication of the 3D spatial mapping is transmitted 1912 to the virtual payment identification module 1914, where a virtual payment location, or locations, is identified within the 3D spatial map. An indication of the location, or locations, is transmitted 1916 to the collision detection module 1918, where a collision with the virtual payment location is detected. For example, this may comprise detecting a collision between a limb of a user and/or a virtual element controlled by the user and the virtual payment location. On detecting a collision, an indication is transmitted 1920 to the payment initiation module 1922, where a payment is initiated. An indication that a payment has been initiated is transmitted 1924 to the payment request transmission module 1926, where a payment request is transmitted, for example via a network such as the internet, to a, for example, payment server (not shown). On confirming the payment request, for example at the server, confirmation is transmitted 1928, for example via the network, to the payment confirmation receiving module 1930. On receiving confirmation of the payment, the payment confirmation receiving module transmits 1932 an indication of the payment to the output module 1934, where the payment confirmation module 1936 generates a confirmation of the payment for output. This may comprise generating a visual and/or audible confirmation. In other examples, this may alternatively, or additionally, comprise emailing a confirmation of the payment to an email address.

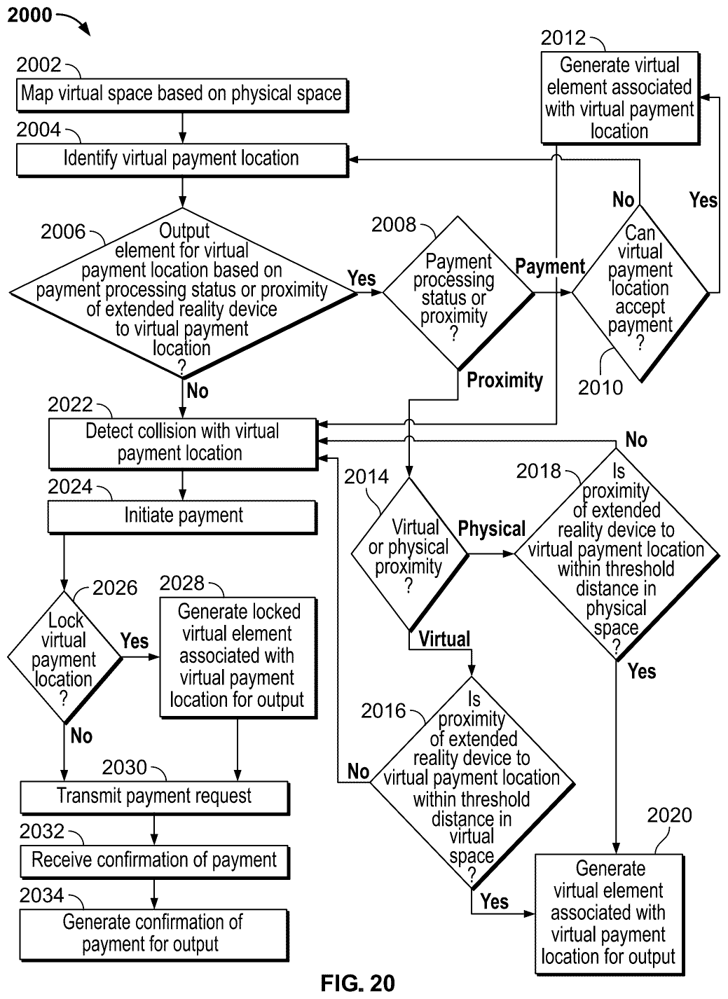

FIG. 20 shows another flowchart of illustrative steps involved in enabling payments in an extended reality environment, in accordance with some embodiments of the disclosure. Process 2000 may be implemented on any of the aforementioned computing devices (e.g., computing device 102, 202, 302, 402, 502, 602). In addition, one or more actions of the process 2000 may be incorporated into or combined with one or more actions of any other process or embodiments described herein.

At 2002, a virtual space is mapped based on a physical space, and at 2004, a virtual payment location is identified in the virtual space. At 2006, it is determined whether to output a visual element for a virtual payment location based on a payment processing status, a proximity of an extended reality device to virtual payment location, or whether to not output a visual element at all. If it is determined that a visual element is to be output, the process proceeds to step 2008, where it is determined whether to output an element based on payment status or proximity (in some examples, not shown, visual elements may be output based on both the payment status and proximity). If the visual element is to be generated for output based on the payment processing status, it is determined whether a virtual payment location can accept payment at 2010. If a virtual payment location cannot accept payment, the process returns to step 2004. If a virtual payment location can accept payment, then, at 2012, a virtual element associated with the virtual payment location is generated for output, indicating that the virtual payment location is available for processing a payment. In some examples, not shown, an element may be generated for output indicating that a virtual payment location is not available for processing a payment. The process proceeds from step 2012 to step 2022.

If, at 2008, it is determined that a visual element for a virtual payment location is to be generated based on the proximity of an extended reality device to a virtual payment location, then the process proceeds to step 2014. At step 2014, it is determined whether the proximity of the extended reality device to a virtual payment location is to be based on a virtual location or a physical location of the extended reality device. If the proximity is to be based on a virtual location of the extended reality device, then the process proceeds to step 2016, where it is determined whether the proximity of the extended reality device to the virtual payment location is within a threshold distance in virtual space. If it is within a threshold distance, the process proceeds to step 2020. If it is not within a threshold distance, the process proceeds to step 2022. If, at step 2014, the proximity is to be based on a physical location of the extended reality device, then the process proceeds to step 2018, where it is determined whether the proximity of the extended reality device to the virtual payment location is within a threshold distance in physical space (i.e., a location in physical space that has been mapped to the virtual payment location). If it is within a threshold distance, the process proceeds to step 2020. If it is not within a threshold distance, the process proceeds to step 2022. At 2020, a virtual element associated with the virtual payment location is generated for output.

At 2022, a collision with a virtual payment location is detected, and at 2024, a payment is initiated. At 2026, it is determined whether the virtual payment location with which a payment has been initiated is to be locked. If it is to be locked, at 2028, the virtual payment location is locked and a virtual element indicating that the virtual payment location is locked is associated with the virtual payment location and is generated for output, and the process proceeds to step 2030. If the virtual payment location is not to be locked, then the process proceeds to step 2030. At 2030, a payment request is transmitted, for example, via a network to a payment server. At 2032, confirmation of the payment is received, for example, via the network from the payment server. At 2034, confirmation of the payment is generated for output. This may comprise generating a visual and/or audible confirmation. In other examples, this may alternatively, or additionally, comprise emailing a confirmation of the payment to an email address.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
mapping, at an extended reality device, a virtual space to a physical space;
identifying, in the virtual space, a virtual payment location, wherein the virtual payment location corresponds to a location in the physical space;
detecting a collision with the virtual payment location;
initiating, based on the collision, a payment;
transmitting, from the extended reality device, a payment request;
receiving, at the extended reality device, confirmation of the payment; and
generating, for output, the confirmation of the payment.

2. The method of claim 1, wherein detecting the collision further comprises identifying a collision between a virtual element and the virtual payment location.

3. The method of claim 1, further comprising:
receiving, at the extended reality device, a spatial map of the virtual space;
determining, based on the spatial map, a proximity of the extended reality device to the virtual payment location;
determining that the proximity of the extended reality device to the virtual payment location is within a threshold distance; and
generating, for output, a virtual element associated with the virtual payment location.

4. The method of claim 3, wherein the virtual element associated with the virtual element payment location comprises transaction information associated with the payment.

5. The method of claim 1, further comprising:
identifying, in physical space, a location of the extended reality device;
identifying a proximity of the extended reality device to pre-determined coordinates in physical space;
determining that the proximity of the extended reality device to the pre-determined coordinates is within a threshold distance; and
generating, for output, a virtual element associated with the virtual payment location.

6. The method of claim 1, wherein:
identifying a virtual payment location corresponding to a physical location further comprises identifying a plurality of virtual payment locations, each virtual payment location corresponding to a physical location; and
the method further comprises:
identifying, based on a payment receiving status, a virtual payment location of the plurality of virtual payment locations; and
generating, for output, a virtual element associated with the identified virtual payment location.

7. The method of claim 1, wherein detecting the collision further comprises:
tracking, using limb tracking, a location of a user limb in the physical space;
mapping the location of the user limb to virtual space; and
identifying that the location of at least a part of the user limb in virtual space corresponds to at least a part of the virtual payment location.

8. The method of claim 1 further comprising:
identifying that the payment is in progress;
locking the virtual payment location associated with the payment; and
generating, for output, a virtual element associated with the virtual payment location, wherein the virtual element indicates that the virtual payment location is locked.

9. The method of claim 1 wherein:
the method further comprises:
generating, for output, a payment authorization request;
receiving a payment authorization;
validating the payment authorization; and
receiving confirmation of the payment further comprises receiving confirmation of the payment in response to the payment authorization being validated.

10. The method of claim 1 further comprising:
accessing a user profile;
identifying, via the user profile, a virtual element; and
generating, for output, the identified virtual element at the virtual payment location.

11. A system comprising:
a communication port;
a memory storing instructions; and
control circuitry communicably coupled to the memory and the communication port and configured to execute instructions to:
map, at an extended reality device, a virtual space to a physical space;
identify, in the virtual space, a virtual payment location, wherein the virtual payment location corresponds to a location in the physical space;
detect a collision with the virtual payment location;
initiate, based on the collision, a payment;
transmit, from the extended reality device and via the communication port, a payment request;
receive, at the extended reality device, confirmation of the payment; and
generate, for output, the confirmation of the payment.

12. The system of claim 11, wherein the control circuitry configured to detect the collision is further configured to identify a collision between a virtual element and the virtual payment location.

13. The system of claim 11, wherein the control circuitry is further configured to:
receive, at the extended reality device, a spatial map of the virtual space;
determine, based on the spatial map, a proximity of the extended reality device to the virtual payment location;
determine that the proximity of the extended reality device to the virtual payment location is within a threshold distance; and
generate, for output, a virtual element associated with the virtual payment location.

14. The system of claim 13, wherein the virtual element associated with the virtual element payment location comprises transaction information associated with the payment.

15. The system of claim 11, wherein the control circuitry is further configured to:
identify, in physical space, a location of the extended reality device;
identify a proximity of the extended reality device to pre-determined coordinates in physical space;
determine that the proximity of the extended reality device to the pre-determined coordinates is within a threshold distance; and
generate, for output, a virtual element associated with the virtual payment location.

16. The system of claim 11, wherein:
the control circuitry configured to identify a virtual payment location corresponding to a physical location is further configured to identify a plurality of virtual payment locations, each virtual payment location corresponding to a physical location; and
the control circuitry is further configured to:
identify, based on a payment receiving status, a virtual payment location of the plurality of virtual payment locations; and
generate, for output, a virtual element associated with the identified virtual payment location.

17. The system of claim 11, wherein the control circuitry configured to detect the collision is further configured to:
track, using limb tracking, a location of a user limb in the physical space;
map the location of the user limb to virtual space; and
identify that the location of at least a part of the user limb in virtual space corresponds to at least a part of the virtual payment location.

18. The system of claim 11, wherein the control circuitry is further configured to:
identify that the payment is in progress;
lock the virtual payment location associated with the payment; and
generate, for output, a virtual element associated with the virtual payment location, wherein the virtual element indicates that the virtual payment location is locked.

19. The system of claim 11, wherein:
the control circuitry is further configured to:
generate, for output, a payment authorization request;
receive a payment authorization;
validate the payment authorization; and
the control circuitry configured to receive confirmation of the payment is further configured to receive confirmation of the payment in response to the payment authorization being validated.

20. The system of claim 11, wherein the control circuitry is further configured to:
access a user profile;
identify, via the user profile, a virtual element; and
generate, for output, the identified virtual element at the virtual payment location.

21-30. (canceled)
